(19) United States
(12) Patent Application Publication
(10) Pub. No.: US 2024/0364048 A1
(43) Pub. Date: Oct. 31, 2024

(54) CONNECTOR

(71) Applicant: Japan Aviation Electronics Industry, Limited, Tokyo (JP)

(72) Inventor: Manatsu Kanai, Tokyo (JP)

(21) Appl. No.: 18/602,692

(22) Filed: Mar. 12, 2024

(30) Foreign Application Priority Data
Apr. 27, 2023 (JP) 2023-073220

(51) Int. Cl. H01R 13/62; H01R 13/10; H01R 13/187; H01R 13/405; H01R 13/502

(52) U.S. Cl. CPC H01R 13/62; H01R 13/10; H01R 13/187; H01R 13/405; H01R 13/5025

(57) ABSTRACT

A connector includes a connector terminal having a flat connection surface, spherical balls disposed on the connection surface, a ball retention member rotatably retaining the balls, a ball guide portion movably retaining the ball retention member in a two-dimensional manner along the connection surface, and a terminal spring pressing the counter connector terminal or the connection surface in a direction closer together, the ball guide portion including return springs disposed to surround the ball retention member along the connection surface, the ball retention member moving along the connection surface in accordance with movement of the counter connector terminal, the counter connector terminal inserted in the counter connector terminal housing portion being pressed against the connection surface by the terminal spring, contacting protruding parts of surfaces of the balls retained in the ball retention member, and being electrically connected to the connector terminal via the balls.

### BACKGROUND OF THE INVENTION

The present invention relates to a connector, particularly to a connector having a counter connector terminal housing portion in which a part of a counter connector terminal is inserted.

Conventionally, there has been known a connector having a metal ball serving as a contact that is movably disposed between a connector terminal and a counter connector terminal for the purpose of reducing the sliding resistance of the counter connector terminal inserted into and pulled out from the connector terminal. The connector terminal is electrically connected to the counter connector terminal via the metal ball.

For instance, JP 2019-67499 A discloses a connector in which a connector terminal 2 is electrically connected to a counter connector terminal 3 in a connector housing 1 made of a resin material, as shown in FIG. 12. Three metal balls 5 held by a contact holder 4 and a diagonally wound coil spring 6 are disposed in the connector housing 1, and the connector terminal 2 is pressed against the three metal balls 5 by the diagonally wound coil spring 6 and thereby electrically connected to the counter connector terminal 3 via the three metal balls 5.

The three metal balls 5 are housed together with compression coil springs 8 separately in three contact housing portions 7 formed in the contact holder 4 as shown in FIG. 13. When the counter connector terminal 3 is inserted into the connector housing 1, the three metal balls 5 rotate and move in accordance with movement of the counter connector terminal 3 while elastically compressing the corresponding compression coil springs 8. This structure reduces the sliding resistance during insertion of the counter connector terminal 3.

Meanwhile, the three contact housing portions 7 formed in the contact holder 4 extend in parallel along an insertion direction D of the counter connector terminal 3 as shown in FIG. 13. Thus, the three metal balls 5 cannot move in a direction perpendicular to the insertion direction D of the counter connector terminal 3 while being able to rotate and move along the insertion direction D.

Accordingly, when the counter connector terminal 3 moves relative to the connector terminal 2 in a direction different from the insertion direction D due to, for instance, receipt of a certain external force during insertion of the counter connector terminal 3 into the connector housing 1 or in the connected state between the connector terminal 2 and the counter connector terminal 3, the sliding resistance cannot be reduced, which may result in lower reliability of electrical connection between the connector terminal 2 and the counter connector terminal 3.

### SUMMARY OF THE INVENTION

The present invention has been made to overcome the conventional problem as above and aims at providing a connector that can establish electrical connection between a connector terminal and a counter connector terminal with high reliability no matter which direction the counter connector terminal moves relative to the connector terminal.

A connector according to the present invention is one having a counter connector terminal housing portion in which part of a counter connector terminal is inserted, the connector comprising:
a connector terminal having a connection surface in a flat shape that faces the counter connector terminal inserted in the counter connector terminal housing portion;
a plurality of balls in a spherical shape being disposed on the connection surface, at least surfaces of the plurality of balls having electrical conductivity;
a ball retention member rotatably retaining the plurality of balls in such a manner part of the surfaces of the plurality of balls contacts the connection surface and another part of the surfaces of the plurality of balls that faces opposite from the connection surface protrudes;
a ball guide portion fixed to the connector terminal and retaining the ball retention member such that the ball retention member is movable in a two-dimensional manner along the connection surface; and
a terminal spring pressing the counter connector terminal inserted in the counter connector terminal housing portion or the connection surface of the connector terminal in a direction closer together,
wherein the ball guide portion includes a plurality of return springs that are disposed to surround the ball retention member along the connection surface and act to return the ball retention member to an initial position on the connection surface,
the ball retention member moves in a two-dimensional manner along the connection surface in accordance with movement of the counter connector terminal when the counter connector terminal is inserted into the counter connector terminal housing portion and in a connected state between the counter connector terminal and the connector terminal, and the ball retention member returns to the initial position due to action of the plurality of return springs when the counter connector terminal is pulled out from the counter connector terminal housing portion, and
the counter connector terminal inserted in the counter connector terminal housing portion is pressed against the connection surface by the terminal spring, contacts protruding parts of the surfaces of the plurality of balls retained in the ball retention member, and is electrically connected to the connector terminal via the plurality of balls.

### BRIEF DESCRIPTION OF THE DRAWINGS

FIG. 1 is a perspective view showing a connector according to an embodiment of the invention and a counter connector terminal.

FIG. 2 is a perspective view showing a ball assembly mounted on a connector terminal of the connector according to the embodiment.

FIG. 3 is an assembly view of the ball assembly in the embodiment.

FIG. 4 is a perspective view showing a ball retention member in the embodiment.

FIG. 5 is a perspective view showing a spring member of a ball guide portion in the embodiment.

FIG. 6 is a cross-sectional view showing a ball, the ball retention member, and the spring member in the embodiment.

FIG. 7 is a perspective view showing a cover member of the ball guide portion in the embodiment.

FIG. 8 is a plan view showing the ball assembly in the embodiment.

FIG. 9 is a perspective view showing a second end portion of a return spring inserted in an insertion hole of the cover member in the embodiment.

FIG. 10 is a perspective view showing a shell in the embodiment.

FIG. 11 is an enlarged view of a main part of FIG. 8.

FIG. 12 is a cross-sectional view showing a conventional connector.

FIG. 13 is a plan view showing a contact holder and three metal balls of the conventional connector.

### DETAILED DESCRIPTION OF THE INVENTION

An embodiment of the present invention is described below based on the accompanying drawings.

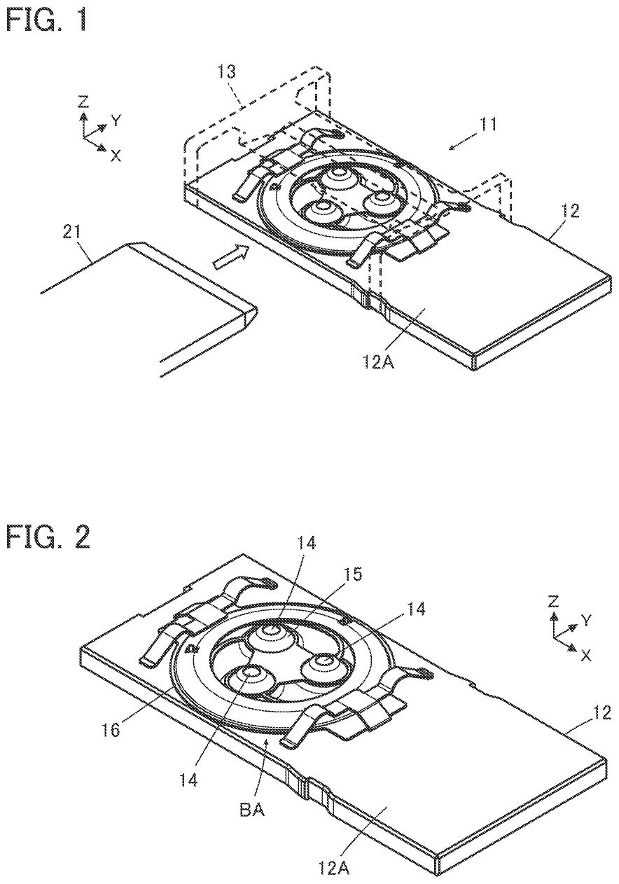

FIG. 1 shows a connector 11 according to the embodiment and a counter connector terminal 21 to be inserted into the connector 11. The connector 11 includes a connector terminal 12 to be electrically connected to the counter connector terminal 21, and a shell 13 illustrated by broken lines is attached to the connector terminal 12.

The counter connector terminal 21 is formed of a plug contact having a flat plate shape. The connector terminal 12 is formed of a socket contact having a flat plate shape as with the counter connector terminal 21, and has a flat connection surface 12A.

For convenience, the flat connection surface 12A of the connector terminal 12 is defined as extending along an XY plane, the direction in which the counter connector terminal 21 is inserted with respect to the connector 11 is defined as a +Y direction, and the direction perpendicular to the connection surface 12A of the connector terminal 12 is defined as a Z direction.

As shown in FIG. 2, a ball assembly BA used for electrically connecting the connector terminal 12 and the counter connector terminal 21 together is mounted on the connection surface 12A of the connector terminal 12. The ball assembly BA includes three balls 14 that relay electrical connection between the connector terminal 12 and the counter connector terminal 21, a ball retention member 15 that rotatably retains the three balls 14, and a ball guide portion 16 that movably retains the ball retention member 15 along the connection surface 12A.

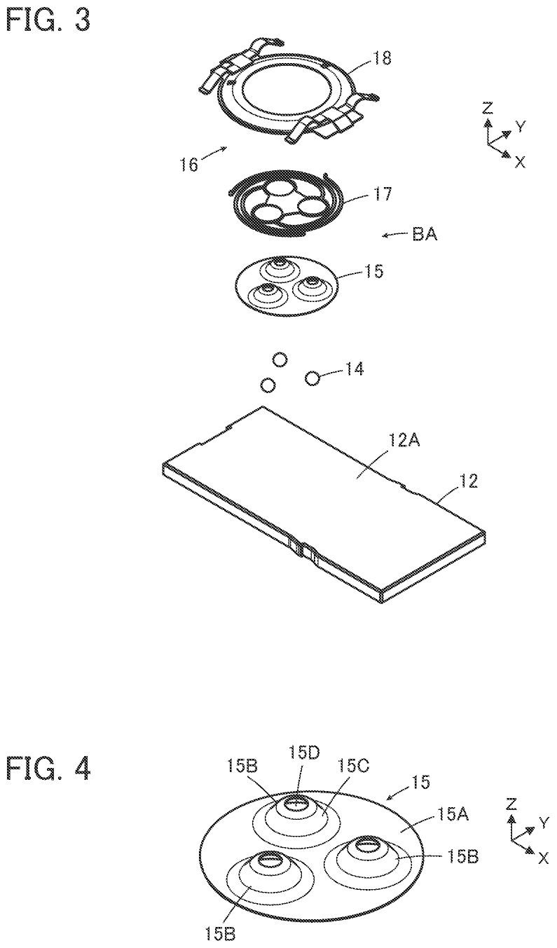

FIG. 3 shows an assembly view of the ball assembly BA. The three balls 14 are disposed on the +Z direction side of the connection surface 12A of the connector terminal 12, the ball retention member 15 is disposed on the +Z direction side of the three balls 14, and a spring member 17 and a cover member 18 that constitute the ball guide portion 16 are sequentially disposed on the +Z direction side of the ball retention member 15.

The three balls 14 are arranged such that all the balls 14 are not aligned in a straight line in an XY plane. In other words, in one example of the embodiment, the three balls 14 are arranged such that the shape formed by connecting the centers of the balls 14 is a triangle in an XY plane. The three balls 14 have a spherical shape having the same diameter and are made of, for instance, electrically conductive metal. It is sufficient for the balls 14 that at least their surfaces are electrically conductive, and for instance, use may be made of balls in each of which an electrically conductive metal layer is formed on a surface of a spherical member made of a nonconductor.

As shown in FIG. 4, the ball retention member 15 is formed of a plate member made of metal or another material, and includes a base portion 15A of disc shape extending along an XY plane and three projection portions 15B projecting in the +Z direction from a surface of the base portion 15A. The three projection portions 15B are arranged at positions of the three vertices of an equilateral triangle whose center corresponds to the center of the base portion 15A of disc shape. Each projection portion 15B has a cone surface 15C tapering toward the +Z direction and is provided with a circular opening 15D at its +Z directional end.

The ball retention member 15 as above is fabricated by, for example, shearing and drawing a flat metal plate, and the three balls 14 can be housed in three recess portions formed on the −Z direction side of the three projection portions 15B.

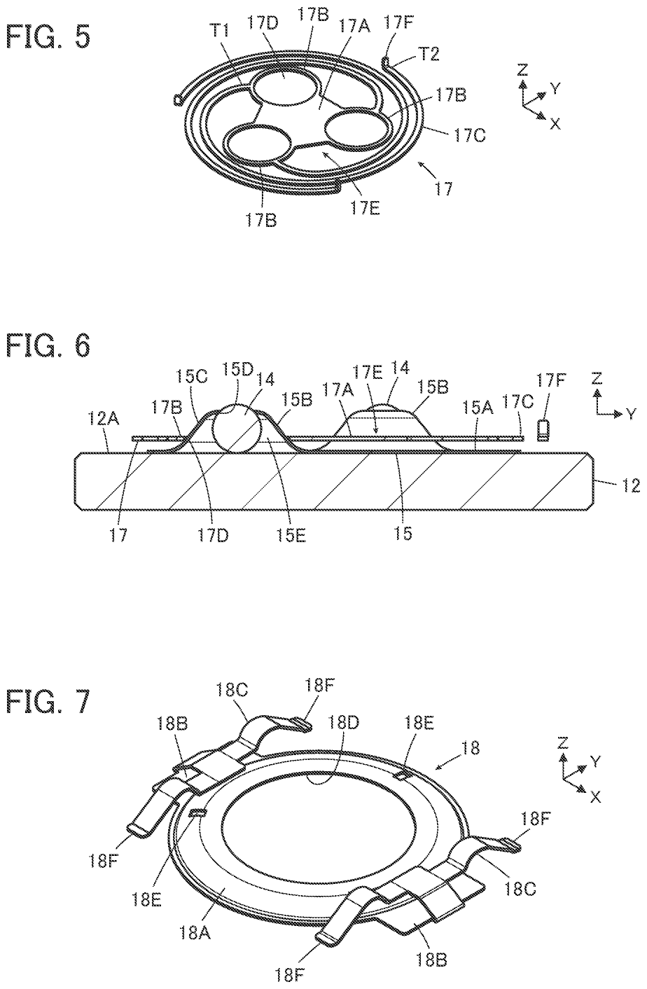

As shown in FIG. 5, the spring member 17 is a plate-like member made of metal or another material, and includes a base portion 17A of equilateral triangular shape extending along an XY plane, three frame portions 17B of arc shape separately joined to the base portion 17A, and three return springs 17C extending separately from the three frame portions 17B. The spring member 17 is fabricated by, for example, shearing a flat metal plate.

The three frame portions 17B of arc shape are disposed at positions of the three vertices of the base portion 17A of equilateral triangular shape, and each frame portion 17B in combination with an arc edge portion of the base portion 17A forms a circular opening portion 17D. The spring member 17 is configured to be fitted to the ball retention member 15 by inserting the three projection portions 15B of the ball retention member 15 into the three opening portions 17D formed by the three frame portions 17B, and the base portion 17A and the three frame portions 17B constitute a fitting portion 17E that is fitted to the ball retention member 15.

The three return springs 17C are formed of band members having the same shape, have a spiral shape extending around the outside of the base portion 17A and the three frame portions 17B, and are elastically deformable in an XY plane. Each return spring 17C includes a first end portion T1 joined to the corresponding frame portion 17B of the fitting portion 17E and a second end portion T2 that is a free end. The second end portion T2 is provided with a bent portion 17F bent toward the +Z direction.

Since the return springs 17C each have a spiral shape, a longer spring length can be ensured while an installation space for the spring member 17 is minimized, and a spring constant can be easily adjusted.

In the ball assembly BA, the ball retention member 15 is disposed such that the surface, on the −Z direction side, of the base portion 15A makes contact with the connection surface 12A of the connector terminal 12 with the balls 14 being housed in ball housing portions 15E of recess shape formed on the −Z direction side of the respective projection portions 15B, as shown in FIG. 6.

The circular opening 15D formed at the +Z directional end of each projection portion 15B of the ball retention member 15 is situated higher than the height corresponding to the radius of the ball 14 and lower than the height corresponding to the diameter of the ball 14 in the +Z direction from the connection surface 12A of the connector terminal 12, and has a smaller diameter than that of the ball 14. Owing to this configuration, the ball 14 housed in the ball housing portion 15E can rotate within the ball housing portion 15E without coming out of the ball housing portion 15E.

Since the projection portion 15B of the ball retention member 15 has the opening 15D as above, the −Z directional end of the ball 14 housed in the ball housing portion 15E surrounded by the connection surface 12A of the connector terminal 12 and the projection portion 15B makes contact with the connection surface 12A, while the +Z directional end of the ball 14 protrudes from the opening 15D in the +Z direction, as shown in FIG. 6.

The spring member 17 is disposed on the ball retention member 15, and the three opening portions 17D formed by the three frame portions 17B make contact separately with the cone surfaces 15C of the three projection portions 15B of the ball retention member 15, whereby the fitting portion 17E of the spring member 17 is fitted to the ball retention member 15. The fitting portion 17E of the spring member 17, the ball retention member 15, and the three balls 14 are configured to be integrally movable in a two-dimensional manner along the connection surface 12A of the connector terminal 12.

As shown in FIG. 7, the cover member 18 is formed of a plate member made of, for example, metal and includes a cover body 18A in a frame shape extending along an XY plane, a pair of fixing portions 18B joined to the opposite ends, in the X direction, of the cover body 18A, and a pair of counter connector terminal guide portions 18C joined to the pair of fixing portions 18B.

The cover body 18A has the shape of a ring having in its center a circular opening portion 18D. A circular outer peripheral portion of the cover body 18A extends along an XY plane, while an inner peripheral portion of the cover body 18A adjacent to the opening portion 18D extends along an XY plane at a height situated on the +Z direction side of the outer peripheral portion. In other words, the cover body 18A has such a shape as to bulge in the +Z direction from the outer peripheral portion toward the inner peripheral portion as a whole. However, the thickness of the cover body 18A in the Z direction has a smaller dimension than the diameter of the ball 14.

The ring-shaped cover body 18A is provided with insertion holes 18E penetrating the cover body 18A in the Z direction at rotational positions spaced at 120-degree intervals about the central axis of the cover body 18A extending in the Z direction.

The pair of fixing portions 18B are used to fix the cover member 18 to the connection surface 12A of the connector terminal 12 and extend in the X direction along an XY plane separately from the +X directional end and the −X directional end of the cover body 18A.

The pair of counter connector terminal guide portions 18C joined to the pair of fixing portions 18B are used to guide the counter connector terminal 21 when the counter connector terminal 21 is inserted into the connector 11 as shown in FIG. 1. Each counter connector terminal guide portion 18C extends in the +Y direction and the −Y direction from the corresponding fixing portion 18B and is formed of a pair of arm portions 18F that are curved in the Z direction.

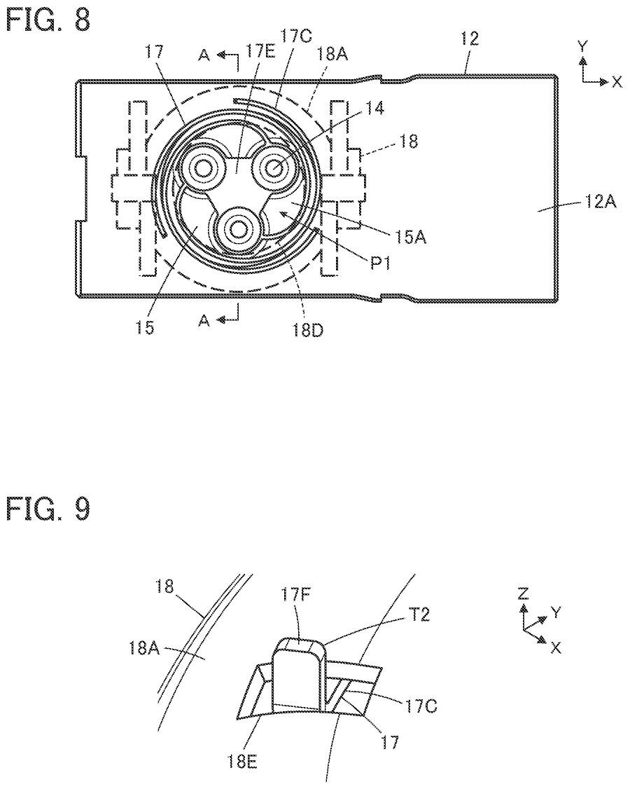

As shown in FIG. 8, the cover member 18 is disposed on the connection surface 12A of the connector terminal 12 to cover the spring member 17 that is fitted to the ball retention member 15 by the fitting portion 17E. In FIG. 8, the cover member 18 is illustrated by dashed lines to show portions covered with the cover member 18.

The three return springs 17C of the spring member 17 have a spiral shape extending along the outer peripheral portion of the ball retention member 15 on the connection surface 12A of the connector terminal 12 and are situated on the −Z direction side of the cover body 18A of the cover member 18, and the +Z directional ends of the three balls 14 retained in the ball retention member 15 are exposed through the opening portion 18D of the cover member 18. In addition, since the thickness of the cover body 18A in the Z direction has a smaller dimension than the diameter of the ball 14, the +Z directional ends of the three balls 14 protrude in the +Z direction from the cover member 18.

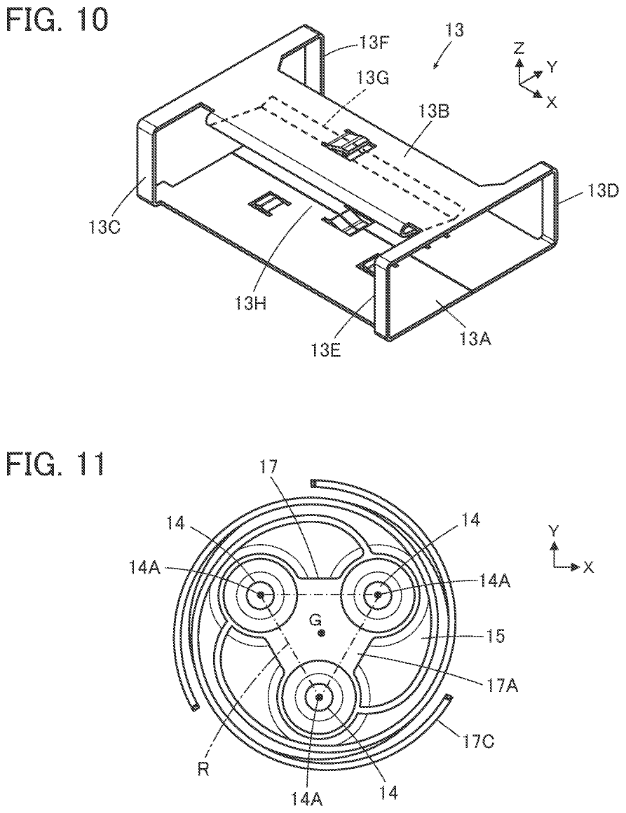

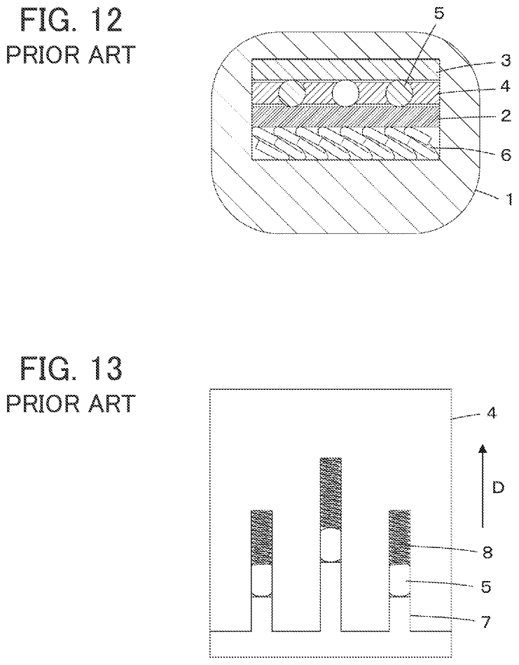

Further, as shown in FIG. 9, the bent portion 17F formed at the second end portion T2 of each return spring 17C of the spring member 17 is inserted in the corresponding insertion hole 18E of the cover body 18A of the cover member 18. Owing to this configuration, the positions of the second end portions T2 of the three return springs 17C are restricted.

Accordingly, when, for instance, the connector terminal 12 is disposed with the connection surface 12A being a horizontal surface and no external force other than gravity acts on the spring member 17, the ball retention member 15, and the three balls 14, as shown in FIG. 8, the three return springs 17C of the spring member 17 lie in a rotationally symmetrical arrangement along the connection surface 12A, and the ball retention member 15 is in an initial position P1 in which the center of the base portion 15A of disc shape substantially coincides with the center of the circular opening portion 18D of the cover member 18.

The insertion hole 18E of the cover body 18A of the cover member 18 is formed to be larger than the bent portion 17F at the second end portion T2 of the return spring 17C as shown in FIG. 9 such that the bent portion 17F is inserted in the insertion hole 18E with an extra margin.

The shell 13 is formed of a plate member such as a bent metal plate as shown in FIG. 10 and includes a bottom plate portion 13A situated on the −Z direction side and extending along an XY plane, a top plate portion 13B situated on the +Z direction side and extending along an XY plane, a front plate portion 13C situated on the −Y direction side and extending along an XZ plane, and a rear plate portion 13D situated on the +Y direction side and extending along an XZ plane.

The front plate portion 13C and the rear plate portion 13D are respectively provided with opening portions 13E and 13F into which the counter connector terminal 21 is to be inserted. A terminal spring 13G extending while being bent in the −Z direction and the +Y direction is formed at the −Y directional end of the top plate portion 13B.

The height of the top plate portion 13B with respect to the bottom plate portion 13A in the Z direction has a larger dimension than the sum of the thickness of the connector terminal 12 in the Z direction, the thickness of the counter connector terminal 21 in the Z direction, and the diameter of the ball 14.

The shell 13 is attached to the connector terminal 12 such that the connector terminal 12 is situated inside the shell 13 to be in contact with the bottom plate portion 13A of the shell 13, and a counter connector terminal housing portion 13H to which the counter connector terminal 21 is to be inserted is formed between the terminal spring 13G and the connection surface 12A of the connector terminal 12.

When the connector 11 is assembled, first, the ball retention member 15 is disposed on the connection surface 12A of the connector terminal 12 while the balls 14 are separately housed in the three ball housing portions 15E of the ball retention member 15 as shown in FIG. 6. At this time, the base portion 15A of the ball retention member 15 makes contact with the connection surface 12A of the connector terminal 12.

Next, the spring member 17 is disposed on the ball retention member 15 such that the three opening portions 17D of the spring member 17 make contact with the cone surfaces 15C of the corresponding projection portions 15B of the ball retention member 15, and the fitting portion 17E of the spring member 17 is fitted to the ball retention member 15.

Further, the cover member 18 is put over the ball retention member 15 and the spring member 17 as shown in FIG. 8, and the bent portions 17F of the three return springs 17C of the spring member 17 are inserted into the corresponding insertion holes 18E of the cover body 18A of the cover member 18 as shown in FIG. 9.

In this state, the pair of fixing portions 18B of the cover member 18 are, in plural positions, welded to the connection surface 12A of the connector terminal 12 by laser welding or another method, whereby the cover member 18 is fixed to the connector terminal 12. Consequently, the fitting portion 17E of the spring member 17, the ball retention member 15, and the three balls 14 are integrally movable along the connection surface 12A of the connector terminal 12 within the cover member 18, and the +Z directional ends of the three balls 14 retained in the ball retention member 15 are exposed through the opening portion 18D of the cover member 18.

After the ball assembly BA is mounted on the connection surface 12A of the connector terminal 12 in this manner, the shell 13 is attached to the connector terminal 12 such that the surface, on the −Z directional side, of the connector terminal 12 makes contact with the bottom plate portion 13A of the shell 13. Thus, the assembling operation of the connector 11 is completed.

It should be noted that since the insertion hole 18E of the cover member 18 is formed to be larger than the bent portion 17F of the return spring 17C as shown in FIG. 9, the bent portion 17F can be inserted into the insertion hole 18E with an extra margin, which facilitates the assembling operation of the connector 11.

Next, the operation of the connector 11 is described. To electrically connect the counter connector terminal 21 to the connector terminal 12 of the connector 11, the counter connector terminal 21 shown in FIG. 1 is moved from the −Y direction toward the +Y direction and inserted into the shell 13 of the connector 11.

In this process, the counter connector terminal 21 is inserted into the shell 13 while being guided by the pair of counter connector terminal guide portions 18C of the cover member 18 shown in FIG. 7 to be parallel to the connection surface 12A of the connector terminal 12, and a +Y directional end portion of the counter connector terminal 21 is inserted into the counter connector terminal housing portion 13H formed between the terminal spring 13G of the shell 13 shown in FIG. 10 and the connection surface 12A of the connector terminal 12 while elastically compressing the terminal spring 13G toward the +Z direction, and is thereby pressed by the terminal spring 13G against the connection surface 12A of the connector terminal 12 in the −Z direction.

As a consequence, the surface of the counter connector terminal 21 on the −Z direction side makes contact at a predetermined contact pressure with the +Z directional ends of the three balls 14 protruding from the cover member 18 in the +Z direction, the three balls 14 being retained in the ball retention member 15, and this allows the −Z directional ends of the three balls 14 to contact the connection surface 12A of the connector terminal 12 at the predetermined contact pressure.

Thus, the counter connector terminal 21 and the connector terminal 12 are electrically connected to each other via the three balls 14.

The three balls 14 contact the surface, on the −Z direction side, of the counter connector terminal 21 and the connection surface 12A of the connector terminal 12 at the predetermined contact pressure and, accordingly, are urged to move in the +Y direction while rotating with the insertion movement of the counter connector terminal 21 into the counter connector terminal housing portion 13H.

However, the positions of the second end portions T2 of the three return springs 17C are separately restricted because the bent portions 17F formed at the second end portions T2 of the respective return springs 17C of the spring member 17 are inserted in the corresponding insertion holes 18E of the cover member 18. Accordingly, the ball retention member 15 being in the initial position P1 as shown in FIG. 8 before insertion of the counter connector terminal 21 moves together with the three balls 14 in the +Y direction along the connection surface 12A of the connector terminal 12 while elastically deforming each of the three return springs 17C.

The three balls 14 disposed between the counter connector terminal 21 and the connector terminal 12 thus move in the +Y direction while rotating, and this makes it possible to reduce the sliding resistance associated with insertion of the counter connector terminal 21 into the counter connector terminal housing portion 13H.

Likewise, the sliding resistance can be reduced also when the counter connector terminal 21 connected to the connector terminal 12 is pulled out from the counter connector terminal housing portion 13H.

Further, since the ball retention member 15 is held to be movable on the connection surface 12A of the connector terminal 12 not only in the Y direction but in a two-dimensional manner in an XY plane, when the counter connector terminal 21 is inserted into or pulled out from the counter connector terminal housing portion 13H, if the counter connector terminal 21 moves relative to the connector terminal 12 in a direction different from the Y direction, the three balls 14 also move in the same direction as the direction of movement of the counter connector terminal 21, thereby reducing the sliding resistance.

Since the three return springs 17C of the spring member 17 lie in a rotationally symmetrical arrangement along the connection surface 12A of the connector terminal 12 when the ball retention member 15 is in the initial position P1, no matter which direction the ball retention member 15 is going to move in an XY plane, equal elastic forces act from the three return springs 17C to the ball retention member 15, so that the ball retention member 15 can smoothly move regardless of the moving direction.

Thus, no matter which direction the counter connector terminal 21 moves relative to the connector terminal 12, the sliding resistance can be effectively reduced.

Aside from that, the counter connector terminal 21 may move relative to the connector terminal 12 not only when it is inserted into or pulled out from the counter connector terminal housing portion 13H but also in the connected state with the connector terminal 12 because of an external force such as vibration acting on the connector 11. Even in such cases, the ball retention member 15 can move together with the three balls 14 in the same direction as the direction of movement of the counter connector terminal 21 regardless of which direction the counter connector terminal 21 moves relative to the connector terminal 12. Thus, the sliding resistance can be reduced, and the connector terminal 12 and the counter connector terminal 21 can be electrically connected to each other with high reliability.

Meanwhile, the three return springs 17C of the spring member 17 do not necessarily need to lie in a rotationally symmetrical arrangement along the connection surface 12A of the connector terminal 12 when the ball retention member 15 is in the initial position P1; as long as the three return springs 17C are arranged to surround the ball retention member 15, substantially equal elastic forces act on the ball retention member 15 owing to the three return springs 17C, so that the ball retention member 15 can smoothly move, thus reducing the sliding resistance.

However, it is preferable that the three return springs 17C lie in a rotationally symmetrical arrangement as shown in FIG. 8 because this allows equal elastic forces to act on the ball retention member 15 in an XY plane regardless of which direction the ball retention member 15 moves.

When the connected state between the connector terminal 12 and the counter connector terminal 21 is released and the counter connector terminal 21 is pulled out from the counter connector terminal housing portion 13H, the ball retention member 15 returns to the initial position P1 shown in FIG. 8 along the connection surface 12A of the connector terminal 12 due to the action of the three return springs 17C.

Aside from that, in the connector 11 according to the embodiment, the spring member 17 is configured such that the center of gravity G of the spring member 17 is situated inside a region R of triangular shape surrounded by the centers 14A of the three respective balls 14 retained in the ball retention member 15 as shown in FIG. 11. Owing to this configuration, the three balls 14 can rotate and smoothly move on the connection surface 12A of the connector terminal 12 together with the ball retention member 15 and the base portion 17A of the spring member 17 when the counter connector terminal 21 moves relative to the connector terminal 12, so that the sliding resistance is effectively reduced, thus improving the reliability of electrical connection between the connector terminal 12 and the counter connector terminal 21.

The center of gravity G of the spring member 17 does not necessarily need to be situated inside the region R surrounded by the centers 14A of the three respective balls 14 retained in the ball retention member 15 and may be situated outside the region R. However, when the center of gravity G of the spring member 17 is situated outside the region R, unequal forces tend to act on the three balls 14, and this may make it difficult to smoothly rotate the three balls 14; therefore, it is preferable that the center of gravity G of the spring member 17 be situated inside the region R. The expression “inside the region R” herein includes a position on the boundary of the region R.

While the three balls 14 are retained in the ball retention member 15 in the embodiment above, the number of the balls 14 is not limited to three, and two or four or more balls 14 may be retained.

Even when such plural balls 14 are retained in the ball retention member 15, the center of gravity G of the spring member 17 is preferably situated inside the region R surrounded by the centers 14A of the plural respective balls 14. When the number of the balls 14 is two, a straight line connecting the centers 14A of the two respective balls 14 is regarded as the “region R,” and the center of gravity G of the spring member 17 is preferably situated on the straight line.

In the embodiment above, the three balls 14 are retained in the ball retention member 15, and the spring member 17 has the three return springs 17C correspondingly; thus, the number of the return springs 17C is the same as the number of the balls 14, but the invention is not limited thereto. However, the number of the return springs 17C is preferably greater than or equal to the number of the balls 14 because with this configuration, elastic forces acting from plural return springs 17C to plural balls 14 via the ball retention member 15 are more likely to be equal, and this allows the plural balls 14 to stably rotate regardless of the moving direction.

In the embodiment above, the terminal spring 13G of the shell 13 contacts the counter connector terminal 21 inserted in the counter connector terminal housing portion 13H and presses the counter connector terminal 21 against the connection surface 12A of the connector terminal 12; however, the invention is not limited thereto.

It is sufficient that the shell 13 has a terminal spring that presses the counter connector terminal 21 inserted in the counter connector terminal housing portion 13H and/or the connection surface 12A of the connector terminal 12 in a direction closer together. For instance, it may be configured such that the connector terminal 12 is pressed against the counter connector terminal 21 by a terminal spring to allow plural balls 14 to contact the surface, on the −Z direction side, of the counter connector terminal 21 and the connection surface 12A of the connector terminal 12 at a predetermined contact pressure.

What is claimed is:

1. A connector having a counter connector terminal housing portion in which part of a counter connector terminal is inserted, the connector comprising:
a connector terminal having a connection surface in a flat shape that faces the counter connector terminal inserted in the counter connector terminal housing portion;
a plurality of balls in a spherical shape being disposed on the connection surface, at least surfaces of the plurality of balls having electrical conductivity;
a ball retention member rotatably retaining the plurality of balls in such a manner part of the surfaces of the plurality of balls contacts the connection surface and another part of the surfaces of the plurality of balls that faces opposite from the connection surface protrudes;
a ball guide portion fixed to the connector terminal and retaining the ball retention member such that the ball retention member is movable in a two-dimensional manner along the connection surface; and
a terminal spring pressing the counter connector terminal inserted in the counter connector terminal housing portion or the connection surface of the connector terminal in a direction closer together,
wherein the ball guide portion includes a plurality of return springs that are disposed to surround the ball retention member along the connection surface and act to return the ball retention member to an initial position on the connection surface,
the ball retention member moves in a two-dimensional manner along the connection surface in accordance with movement of the counter connector terminal when the counter connector terminal is inserted into the counter connector terminal housing portion and in a connected state between the counter connector terminal and the connector terminal, and the ball retention member returns to the initial position due to action of the plurality of return springs when the counter connector terminal is pulled out from the counter connector terminal housing portion, and
the counter connector terminal inserted in the counter connector terminal housing portion is pressed against the connection surface by the terminal spring, contacts protruding parts of the surfaces of the plurality of balls retained in the ball retention member, and is electrically connected to the connector terminal via the plurality of balls.

2. The connector according to claim 1,
wherein the plurality of return springs lie in a rotationally symmetrical arrangement along the connection surface when the ball retention member is in the initial position.

3. The connector according to claim 1,
wherein the ball guide portion includes:
a cover member in a frame shape that is fixed to the connector terminal and has an opening portion through which the plurality of balls retained in the ball retention member are exposed; and
a spring member having the plurality of return springs, fitted to the ball retention member and retained by the cover member.

4. The connector according to claim 3,
wherein the spring member includes a fitting portion fitted to the ball retention member,
the cover member has a plurality of insertion holes formed to correspond to the plurality of return springs, and
each of the plurality of return springs has a first end portion joined to the fitting portion and a second end portion inserted in a corresponding one of the plurality of insertion holes of the cover member so that its position is restricted.

5. The connector according to claim 4,
wherein each of the plurality of return springs has a spiral shape extending along an outer peripheral portion of the ball retention member.

6. The connector according to claim 3,
wherein a center of gravity of the spring member is situated inside a region surrounded by centers of the plurality of balls.

7. The connector according to claim 6,
wherein the plurality of balls consist of three balls disposed on the connection surface so as not to be aligned in a straight line.

8. The connector according to claim 1,
wherein the number of the plurality of return springs is greater than or equal to the number of the plurality of balls.

9. The connector according to claim 1,
wherein the ball retention member is formed of a plate member provided with a plurality of ball housing portions of recess shape in which the plurality of balls are separately housed, and
each of the plurality of ball housing portions has an opening through which part of a corresponding one of the plurality of balls housed protrudes in a direction opposite from the connection surface.

10. The connector according to claim 1, comprising a shell attached to the connector terminal and retaining the terminal spring such that the terminal spring faces the connection surface,
wherein the counter connector terminal housing portion is formed between the terminal spring and the connection surface.
